(19) United States
(12) Patent Application Publication
(10) Pub. No.: US 2002/0136313 A1
(43) Pub. Date: Sep. 26, 2002

(54) Time-sectionalized demodulator

(76) Inventors: Chung-Ping Huang, Hsinchu (TW); Elvis Lin, Kaoshiang (TW); Shaw-Jia Hor, Taoyuan (TW)

Correspondence Address: Hung Chang LIN, 8 Schindler Court, Silver Spring, MD, 20903, US

(21) Appl. No.: 09/816,483

(22) Filed: Mar. 26, 2001

(51) Int. Cl. H04B 14/04

(52) U.S. Cl. 375/242

(57) ABSTRACT

A time sectionalized demodulator for pulse-code modulated (PCM) signal is demodulated by counting the number of carrier cycles including noise cycles to compare with a predetermined minimum number N within a time slot for a high voltage level output. When the counted number exceeds the predetermined number N, a high voltage level is outputted from the comparator. The carrier cycles including noise cycles is modulated and then sectionalized by time slots. By comparing the modulated pulse number with the preset number N within a time slot to filter out noise signal which yields pulses greater than N for high voltage level and to filter out noise signal which yields pulses less than N for low voltage level.

### BACKGROUND OF THE INVENTION

(1) Field of the Invention

This invention relates to wireless communication systems, particularly to the demodulator of a pulse-code modulated (PCM) signal.

(2) Brief Description of Related Art

In a traditional wireless communication system, the modulating signal is encoded and frequency-modulates a high frequency carrier at the transmitter. At the receiver, the received signal with undivided noise signal is amplified, demodulated and decoded for signal processing. Traditional digital decoder feeds the amplified received signal with noise signal to a carrier counter, and the number of the count of carrier cycles including noise cycles corresponds to the coding of the signal. i.e. The coding signal comprises both the normal signal and noise signal and therefore causes error output due to the noise signal to be modulated.

FIG. 1 shows the block diagram of a decoder 10 for a digitally modulated signal. After the modulated carrier is received, the amplified signal is fed to a decoding circuit 10. This decoder 10 comprises a carrier counter 102, a digital comparator 104, a controller 106, which controls the processing. The controller 106 monitors the count of the carrier counter 102 for a fixed time window. When the count equals a predetermined number, the counter 102 is cleared and reset to “0”. The counter counts the number of cycles of the carrier, and feeds the count to a comparator 104 to compare with a predetermined number N, which can be either fixed in the counter or be programmed from a Register 12. The digital comparator compares the count of the counter 102 with the predetermined number N. When the number of pulses of the carrier is equal to N, the digital comparator 104 sends out a signal to the controller 106 and a corresponding signal to the Output Unit 14. Meanwhile the controller 106 also sends out a signal to enable the Output Unit 14.

The problem of the traditional decoder shown in FIG. 1 is illustrated in FIG. 3. Suppose each digital bit contains 5 pulses, i.e. N=5. Two digital bits “1” and “0” are transmitted in sequence as shown in the top row. Since each bit contains 5 pulses, the transmitted digital signal is shown in the second row. Due to noise pickup, the received signal is shown in the second row, where the second pulse becomes pulses 2 to 5, and the fourth transmitted pulse becomes pulses 7 to 10. As a result, the traditional decoder causes the counter to count 11 pulses. The first 5 pulses are decoded as a digital “1”; the second 5 pulses are decoded as another digital “1”; and the zero amplitude pulses after the fifth transmitted pulse at the emitter or after the eleventh received pulses at the receiver are decoded to be digital “0”. Thus, an error has been committed where signal 110 is output instead of the correct signal 10. Therefore, the traditional decoder is not immune to noise.

### SUMMARY OF THE INVENTION

An object of this invention is to provide a demodulator which is immune to noise for wireless pulse-code modulated signal transmission. Another object of this invention is to provide a simple decoder for wireless pulse-code modulated signal transmission.

These objects are achieved by sectionalizing the amplified received signal into a number of “time slots”. Each time slot is shorter than the time window. This invention sets a threshold value (preset number N) of the pulse numbers within a time slot. If the pulses which including noise pulses count equals or greater than N, then the comparator output high voltage level to a latch. The portion of the pulse count greater than N is deemed to be noise for high voltage level and less than N is deemed to be noise for low voltage level within a time slot. With the limitation of pulse numbers within a time slot, the noise signal is omitted. Thus noise immunity is achieved.

### BRIEF DESCRIPTION OF THE DRAWINGS

FIG. 1 shows a prior art decoder for a pulse code modulated signal.

FIG. 2 shows the demodulator and a decoder of the present invention.

FIG. 3 shows the timing diagram of the received signal and the resultant output in the presence of noise in the prior art

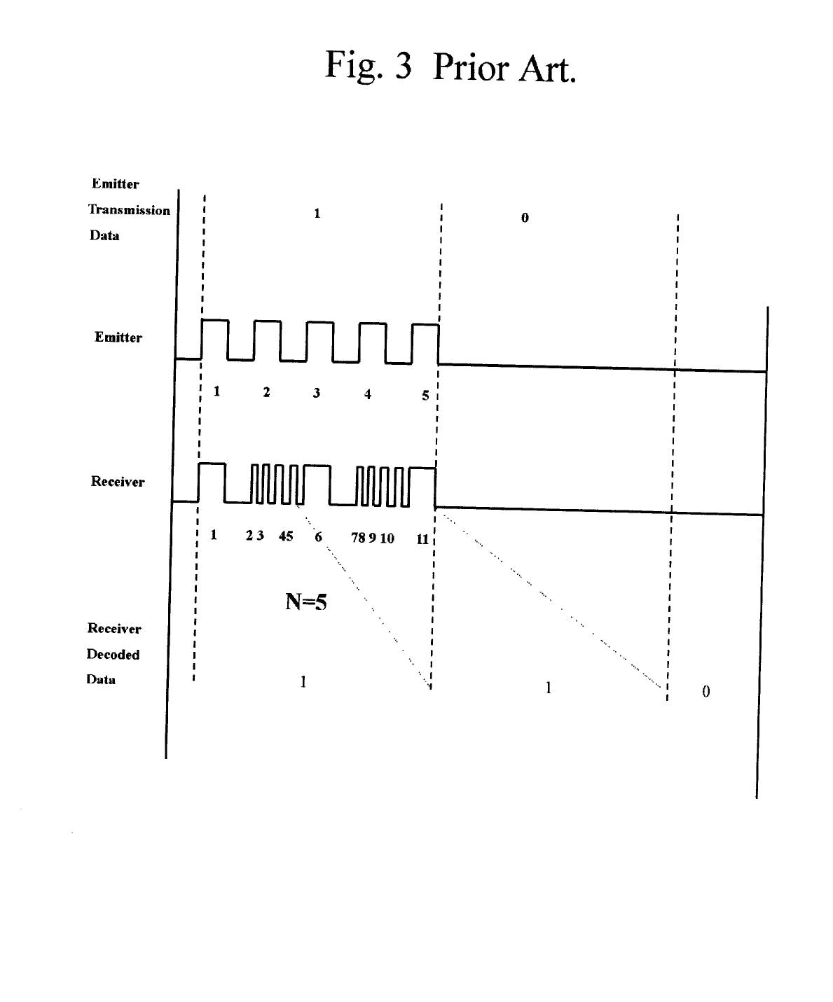

FIG. 4 shows the timing diagram of the resultant output in the presence of noise using the “time sectionalized modulation” of the present invention.

FIG. 5 shows the timing diagram of second example of time sectionalized modulation.

### DETAILED DESCRIPTION OF THE INVENTION

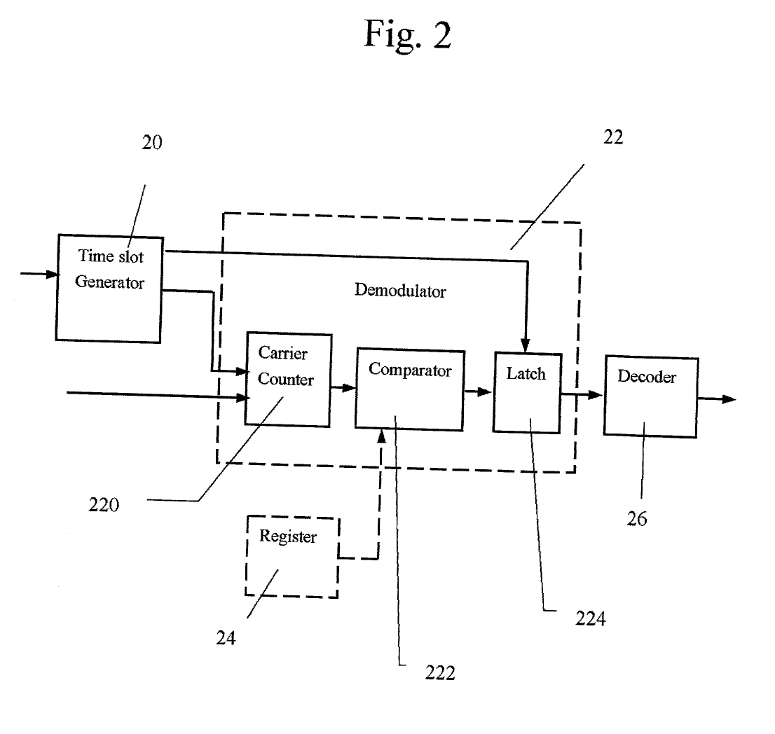

FIG. 2 shows the block diagram of the demodulator of the present invention. The incoming pulse-code modulated signal is fed to a carrier counter 220. A Time Slot Generator 20 generates time slots. The time slot is shorter than the time window. The output of the carrier counter 220 is compared with the preset number N within a time slot and then if the carrier count equals or greater than N, then a high voltage level is output from comparator 222 to a Latch 224, which is enabled by the output of the time slot generator 20. Thus, the output of the comparator 222 is latched before the end of every time slot. Any noise is subject to the threshold value (preset number N) within a time slot and then does not yield a significant output to the output of the Latch 224. The output of the Latch 224 feeds a Decoder 26 to decode the voltage level into digital signal.

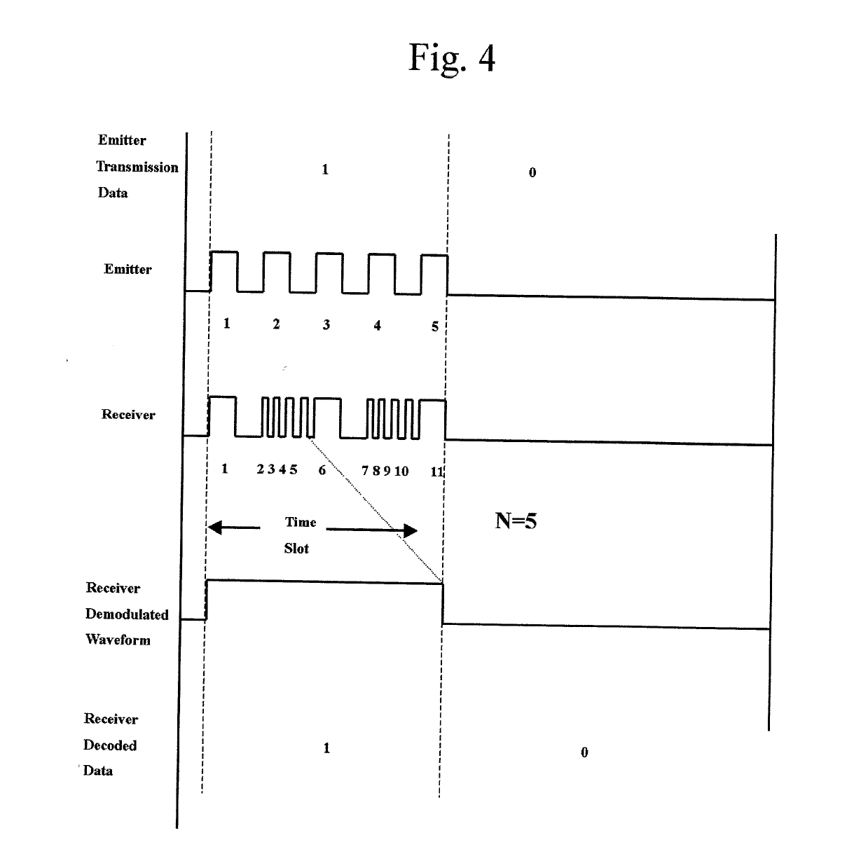

FIG. 4 shows the timing diagram of the different signals of the demodulator shown in FIG. 2 as an example. The emitter transmission data are “1” and “0” in sequence. Each bit of digital signal modulates five cycles of carrier signal, i.e. N=5. The digital “1” modulates the carrier as five full amplitude pulses 1, 2, 3, 4, 5; and the digital “0” transmits next five zero amplitude pulses. At the receiver, the modulated signal is distorted by the presence of noise pulses 2, 3, 4, 5 and 7,8, 9, 10. Because there are eleven (11) pulses within a single time slot, which is more than the preset pulse number N five (5) in this example in each time slot, high voltage level is outputted in the demodulated wave in this example. The demodulated waveform is immune from the disturbance of the noisy pulses 2, 3, 4, 5 and 7, 8, 9, 10, because the demodulated wave from latch 224 counts the first five pulses 1,2,3,4,5=to meet the rule of preset number of five within a time slot, in this example, and then to output a single high voltage level in next time slot. The demodulated waveform yields a waveform as shown, representing the “1” “0” sequence as transmitted without any disturbance of noise signal.

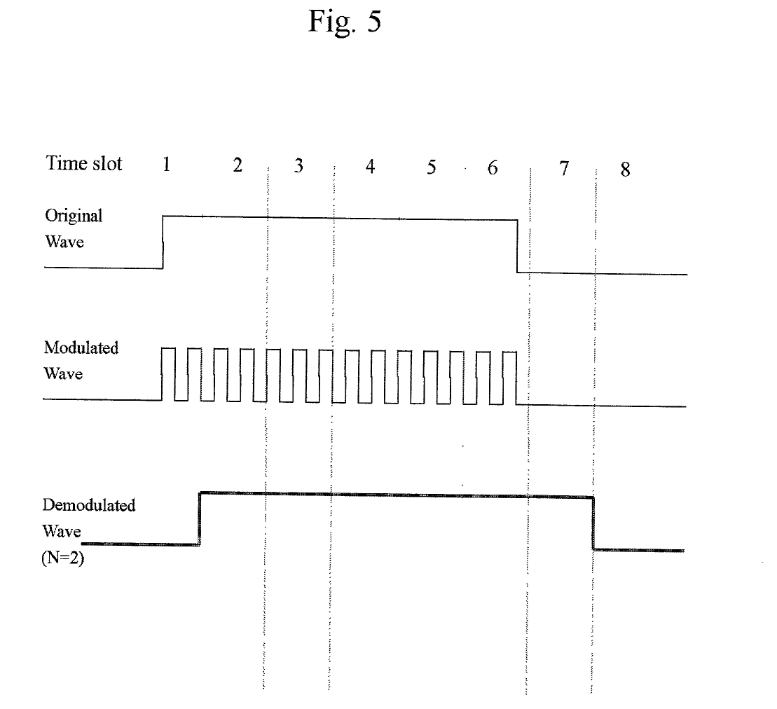

FIG. 5 shows another example of time slot modulation. The carrier cycles including noise cycles is modulated, showing 14 cycles for each data bit in the example. Modulated pulses is sectionalized with a number of time slots (6 time slots in the example). There are two pulses in each of the 1, 2, 4, 6 time slots, and three pulses in each of 3 and 5 time slots at the modulated wave form. Since they are all equal to or more than two pulses in each time slot, the preset number N is set to be two (2) in the example of FIG. 5, high voltage level is outputted in next time slot at the demodulated waveform. With the time slot demodulation, the demodulated wave is immune from any noise such as the three pulses in 3 and 5 time slots. The preset number N in this invention can be set to be any positive integer, i.e. N is at least equal to one.

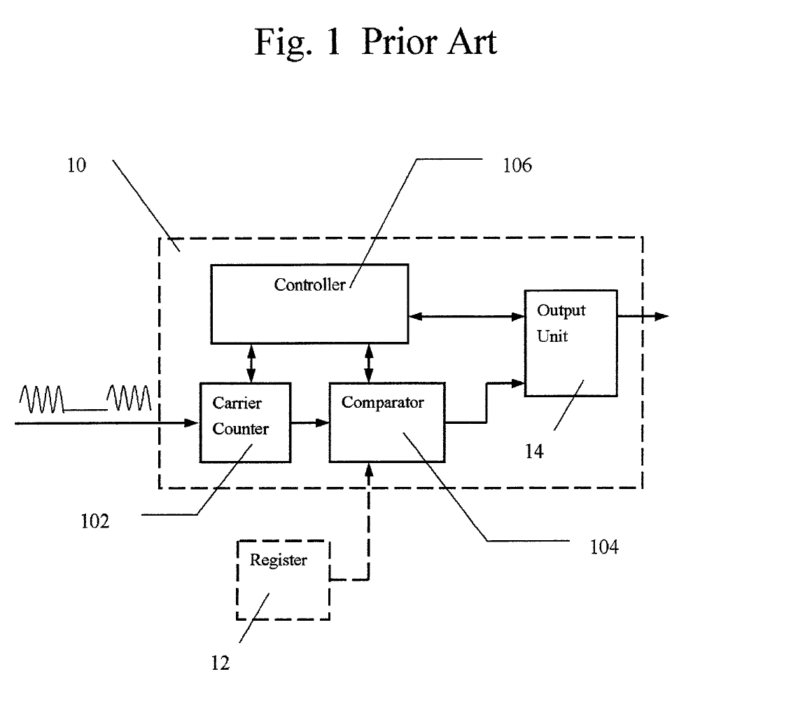

As in the prior art shown in FIG. 1, the time window can be programmed by a register 24 instead of being preset in the counter 220.

While the preferred embodiment of the invention has been described, it is apparent to those skilled in the art that various modifications may be made in the embodiment without departing from the spirit of the present invention. Such modifications are all within the scope of this invention.

1. A time sectionalized demodulator for pulse code modulated signal, comprising:
a carrier counter for counting the number of pulses of an incoming signal within a time slot;
a digital comparator for comparing said number of pulses with a preset number N , yielding a high voltage level when the number of pulses equals or exceeds N and a digital “0” when the number of pulses is less than N;
a time slot generator for generating time slots shorter than time window, and for sectionalizing said incoming signal; and
a latch fed by said comparator and enabled by said time slot generator to output voltage level at the end of each time slot.

2. A time sectionalized demodulator as described in claim 1, further comprising a decoder for converting the voltage output of said latch into digital signal.

4. A time sectionalized demodulator as described in claim 1, wherein said preset number is at least equal to one.

5. A time sectionalized demodulator as described in claim 1, wherein the number of time slots per time window is at least one.

6. A time sectionalized demodulator as described in claim 1, wherein said preset number is preset within said comparator.

7. A time sectionalized demodulator as described in claim 1, wherein said preset number is programmed by a register.
